(19) United States
(12) Patent Application Publication
(10) Pub. No.: US 2019/0352979 A1
(43) Pub. Date: Nov. 21, 2019

(54) SYSTEM FOR MOVING A TRANSFER BRIDGE CRANE

(71) Applicant: SCHLUMBERGER TECHNOLOGY CORPORATION, Sugar Land, TX (US)

(72) Inventor: James Arthur Zapico, Houston, TX (US)

(21) Appl. No.: 15/984,503

(22) Filed: May 21, 2018

(51) Int. Cl. E21B 19/14; B66C 17/06; B66C 11/18

(52) U.S. Cl. CPC E21B 19/14; B66C 11/22; B66C 11/18; B66C 17/06

(57) ABSTRACT

A system for moving a bridge crane includes a first drive and a second drive coupled to a support structure, a first sheave and a second sheave coupled to the support structure, and third sheaves coupled to a beam movable in a first axis. The system includes a first line coupled to the first drive, the first sheave, the second sheave, and one or more of the third sheaves. The first line is coupled to a gripping assembly that is coupled to the beam and movable in a second axis. The system includes a second line coupled to the second drive, the first sheave, the second sheave, and the third sheaves. The second line is coupled to the gripping assembly. Rotating the first and second drives causes the beam and the gripping assembly to move in the first axis and/or the gripping assembly to move in the second axis.

### BACKGROUND

Oil rigs often include one or more cranes for moving stands of drill pipe, casing, or other oilfield tubulars between pipe handling equipment and other structures during tripping in or tripping out operations. One type of crane that may be used is a bridge crane. Bridge cranes generally include a horizontal beam supported at both ends. A trolley or another type of device is movable along the beam. The beam is movable in at least one horizontal axis, e.g., transverse to the direction in which the beam extends, thereby giving the trolley a two-axis range of motion. The trolley is, in turn, coupled to a hoist or another type of gripping assembly, so as to suspend the oilfield tubulars from the crane.

A transfer bridge crane is a specific type of bridge crane, which is used on drilling rigs to move tubulars or stands of tubulars between pipe handling equipment and storage, specifically a racking board. In earlier rig designs, this task was often undertaken at least partially by hand, with a rig worker, called a derrickman, physically guiding the tubulars into position. This generally calls for the rig worker to be at an elevated position while guiding the heavy tubulars, which can be a stressful, potentially dangerous position for a rig worker. The advent of the transfer bridge crane may perform this task.

Transfer bridge cranes include systems to move the pipe gripping member with respect to the drilling rig. Such crane-moving systems come in a variety of designs. For example, two rack-and-pinion assemblies may be provided, one for moving the crane through each of the two horizontal axes. While this is widely used and successful in implementation, the rack-and-pinion designs can be prone to wear. Another design that has been used has lines connected to the transfer bridge crane and also to drivers. Depending on the rotation direction of the drivers, the lines pull the crane in either direction along an axis of movement. However, a rack-and-pinion is still used to move in a second axis.

### SUMMARY

Embodiments of the disclosure may provide a system for moving a bridge crane. The system includes a first drive coupled to a support structure, a second drive coupled to the support structure, a first sheave coupled to the support structure, a second sheave coupled to the support structure, and a plurality of third sheaves coupled to a beam of the bridge crane. The beam is movable in a first axis. The system also includes a first line coupled to the first drive, the first sheave, the second sheave, and one or more of the third sheaves. The first line is coupled to a gripping assembly that is coupled to the beam and movable in a second axis, along the beam. The system further includes a second line coupled to the second drive, the first sheave, the second sheave, and one or more of the third sheaves. The second line is coupled to the gripping assembly. Rotating the first and second drives causes the beam and the gripping assembly to move in the first axis, the gripping assembly to move in the second axis along the beam, or both.

Embodiments of the disclosure may also provide a bridge crane for moving oilfield tubulars into a racking board. The bridge crane includes a horizontal beam coupled to a support structure and configured to move in a first axis with respect to the support structure, the racking board being coupled to the support structure, and a gripping assembly coupled to the beam and configured to move in a second axis with respect thereto. The gripping assembly includes an engaging device configured to handle an oilfield tubular and move the oilfield tubular within the support structure. The bridge crane also includes a system for moving the beam and the gripping assembly. The system includes a first drive coupled to the support structure, a second drive coupled to the support structure, a first sheave coupled to the support structure, a second sheave coupled to the support structure, a plurality of third sheaves coupled to the beam, a first line coupled to the first drive, the first sheave, the second sheave, and one or more of the third sheaves. The first line is connected to the gripping assembly. The system further includes a second line coupled to the second drive, the first sheave, the second sheave, and one or more of the third sheaves. The second line is connected to the gripping assembly. Actuation of the first and second drives causes the beam and the gripping assembly to move in the first axis, the gripping assembly to move in the second axis along the beam, or both.

Embodiments of the disclosure may also provide a method including engaging an oilfield tubular using an engaging device of a gripping assembly of a bridge crane, and moving the gripping assembly in a first axis with respect to a support structure of the bridge crane. Moving the gripping assembly in the first axis includes moving a horizontal beam coupled to the gripping assembly in the first axis by driving a first drive and a second drive in opposite rotational direction. The method also includes moving the gripping assembly in a second axis with respect to the support structure. Moving the gripping assembly in the second axis includes moving the gripping assembly in the second axis with respect to the horizontal beam by driving the first and second drives in the same rotational direction. Driving the first drive to rotate applies a tension on a first line. The first line is received through one or more first sheaves coupled to the beam and is connected to the gripping assembly, such that the first line transmits the force applied by the rotation of the first drive to both the beam and the gripping assembly. Further, driving the second drive to rotate applies a tension on a second line. The second line is received through one or more second sheaves coupled to the beam and is connected to the gripping assembly, such that the second line transmits the force applied by the rotation of the second drive to both the beam and the gripping assembly.

### BRIEF DESCRIPTION OF THE DRAWINGS

The present disclosure may best be understood by referring to the following description and accompanying drawings that are used to illustrate one or more embodiments. In the drawings:

FIG. 1 illustrates a perspective view of a racking assembly attached to a mast of a drilling rig, according to an embodiment.

FIG. 2 illustrates a simplified, side view of the transfer bridge crane in the support structure, according to an embodiment.

FIG. 3 illustrates a perspective view, looking down at the top of the transfer bridge crane and the support structure, according to an embodiment.

FIG. 4 illustrates an elevation view, looking at the V-door side of the support structure, according to an embodiment.

FIGS. 5, 6, and 7 illustrate schematic, plan views of the transfer bridge crane in different operational modes, according to an embodiment.

FIG. 8 illustrates a schematic view of a first hydraulic circuit for the transfer bridge crane, according to an embodiment.

FIG. 9 illustrates a schematic view of a second hydraulic circuit for the transfer bridge crane, according to an embodiment.

FIG. 10 illustrates a flowchart of a method for moving a transfer bridge crane, according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

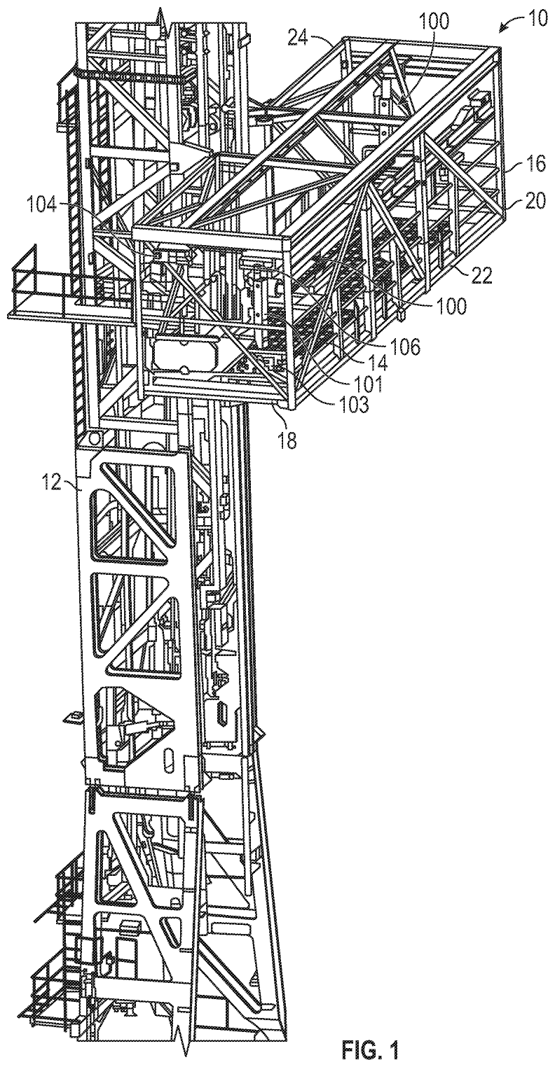

FIG. 1 illustrates a perspective view of a racking assembly 10 attached to a mast 12 of a drilling rig, according to an embodiment. As shown, the racking assembly 10 generally includes a racking board 14 and a support structure (or frame) 16, with the racking board 14 generally being positioned at the bottom of the support structure 16. The racking board 14 may have a plurality of slots or rows between fingers configured to receive tubulars, e.g., drill pipe stands, therein, allowing the tubulars to be stored in a vertical orientation on the drilling rig, for subsequent deployment into a wellbore.

The support structure 16 may have a driller's side 18, an off-driller's side 20, a drawworks side 22, and a V-door side 24. The V-door side 24 may face and be attached to the mast 12, and the drawworks side 22 may face away from the mast 12. Pipe handling equipment may be used to bring the tubulars into proximity of the V-door side 24 for receipt into the racking board 14. The support structure 16 or racking board 14 may include one or more movable beams, which may be pivoted or otherwise moved to allow receipt of the vertically-oriented tubulars therethrough and into/out of the racking board 14. The driller's side 18 and the off-driller's side 20 may be defined with respect to the location of the drilling control room (not shown) on the rig, with the driller's side 18 facing the side of the rig on which the control room is positioned, and the off-driller's side 20 facing away therefrom.

One or more transfer bridge cranes 100 (two are shown by way of example) may be coupled to the support structure 16. The transfer bridge crane 100 may be configured to receive tubulars on the drawworks side 22 of the support structure 16 and move the tubulars into position on the racking board 14. The transfer bridge crane 100 may thus include a gripping assembly 101, which includes an engagement device 103 that is configured to be received at least partially around a tubular and may engage or otherwise handle the tubular (e.g., via slips, a bushing, etc.). The engagement device 103 may be configured to release the tubulars once in position on the racking board 14. The transfer bridge crane 100 may also be used to remove tubulars from the racking board 14, e.g., by gripping the tubulars from within the racking board 14, and moving them through the support structure 16 in a horizontal plane until handing the tubulars off to other pipe handling equipment. The gripping assembly 101 may also be capable of vertical movement, so as to change the elevation of an oilfield tubular handled thereby.

The transfer bridge crane 100 also includes a system for moving the gripping assembly 101 with respect to the support structure 16 and racking board 14. In an embodiment of the present disclosure, such system may include two drives 104, 106, which may be capstan drives mounted to the support structure 16. A system of sheaves and lines (defined herein to include cables, chains, belts, ropes, braided lines, and single-strand lines) may be actuated using the drives 104, 106, which provides for the movement of the gripping assembly 101 through at least two axes in the horizontal plane. The drives 104, 106 may include encoders or the like to track a position thereof, from which a position of the gripping assembly 101 may be calculated. In other embodiments, other types of systems for tracking the position of the gripping assembly 101 may be employed.

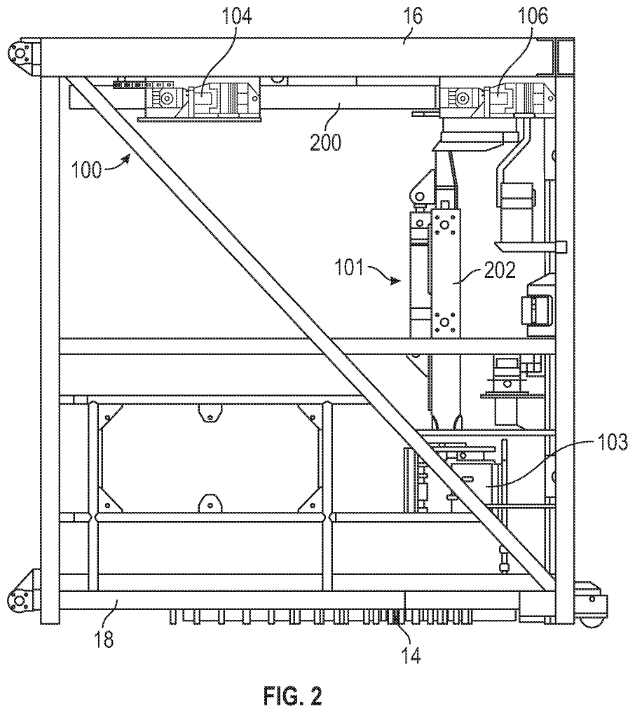

FIG. 2 illustrates a simplified, side view of the transfer bridge crane 100 in the support structure 16, according to an embodiment. As shown, the transfer bridge crane 100 includes a horizontal beam 200, which is movable in a transverse direction (into and out of the page, in this view). The engagement device 103 may be positioned below the beam 200 and connected thereto by an arm 202 of the gripping assembly 101. The gripping assembly 101 may be movable with respect to the beam 200 in a direction along the length of the beam 200. For example, the gripping assembly 101 may include a wheeled connection (e.g., a trolley) or another type of connection with the beam 200 that allows for movement of the gripping assembly 101 along the beam 200. The two drives 104, 106, both positioned on the same side of the support structure 16 (e.g., the driller's side 18), may provide for movement of the gripping assembly 101 in both horizontal axes.

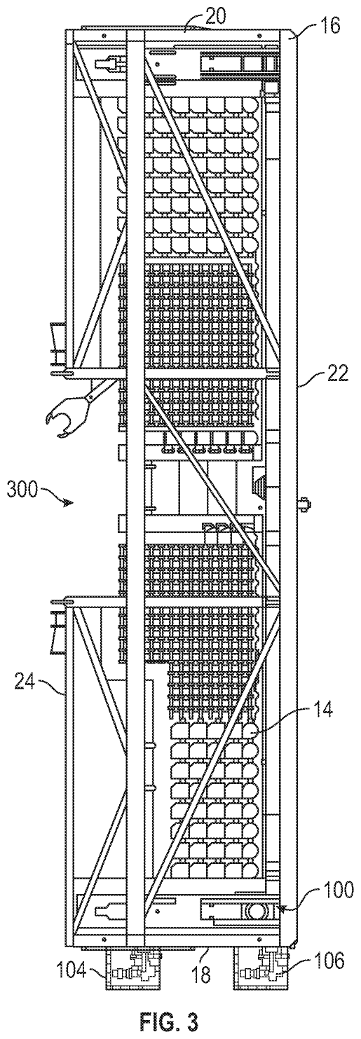

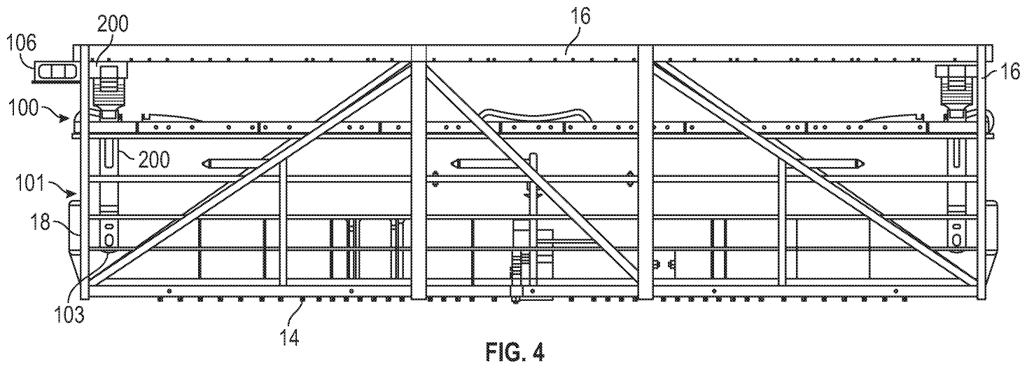

FIG. 3 illustrates a perspective view, looking down at the top of the transfer bridge crane 100 and the support structure. FIG. 4 illustrates an elevation view, looking at the drawworks side 22 of the support structure 16. From these views, it can be appreciated that a tubular, extending in a vertical orientation, may be brought into proximity of a middle section 300 of the V-door side 24. The gripping assembly 101 may be brought into position via the drives 104, 106, as will be described in greater detail below, grip the tubular, and move the tubular into position in the racking board 14. The reverse operation may be employed to remove a tubular from the racking board 14 using the transfer bridge crane 100.

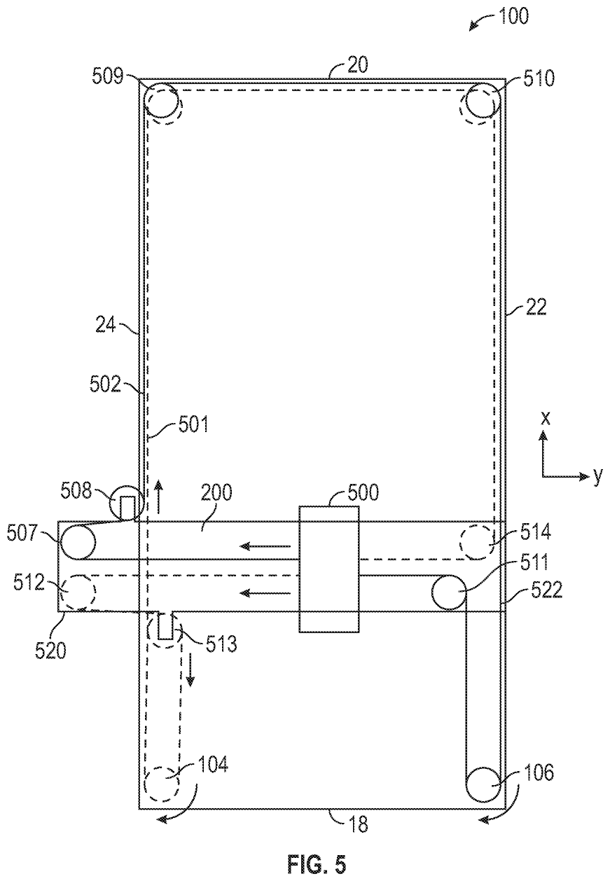

FIG. 5 illustrates a schematic, plan view of the system for moving a transfer bridge crane 100, according to an embodiment. The horizontal beam 200 may be oriented, as shown, extending generally parallel to the driller's side 18 and the off-driller's side 20. The direction extending perpendicular to the driller's side 18 and the off-driller's side 20 may be referred to as the x-axis, and the direction perpendicular thereto (along which the beam 200 extends), may be referred to as the y-axis. Further, pipes or other tubulars, which may be moved by the transfer bridge crane 102 and into position for various other pipe handling components to manipulate, may be positioned in the racking board 14, below the transfer bridge crane 102. In an embodiment, the beam 200 may extend past the V-door side 24, as shown. The reason for this, referring again to FIG. 2, is that the gripping assembly 101 receives a tubular from the pipe handling equipment in the middle section 300, to the left (in this view) of the V-door side 24 of the support structure 16. In other embodiments, the gripping assembly 101 could be otherwise extendable laterally past the end of the beam 200, and thus the beam 200 might not extend past the V-door side 24.

Referring again to FIG. 5, and turning to the system for moving the gripping assembly 101, as mentioned above, the gripping assembly 101 may include a movable connection with the beam 200, e.g., a trolley 500 (which may be any wheeled or otherwise low-friction, movable connection). Further, the aforementioned drives 104, 106 may engage two lines 501, 502, which may be receivable through the drives 104, 106. Rotation of the drives 104, 106 may thus pull the lines 501, 502 in a direction tangent to such rotation. The lines 501, 502 may each extend from and back to the trolley 500, for example, each end of each line 501, 502 may be connected to an opposite side of the gripping assembly 101.

The system 100 may also include a plurality of sheaves 507, 508, 509, 510, 511, 512, 513, 514. The sheaves 509, 510 may be secured to a relatively stationary structure, such as the support structure 16 or another frame, and may be positioned opposite to the drives 104, 106, e.g., on the off-driller's side 20. The remaining sheaves 507, 508, 511-514 may be secured to the beam 200, as shown. For example, the sheaves 507, 512 may be positioned proximate to a first, e.g., V-door side, end 520 of the beam 200. The sheaves 508, 513 may be positioned between the V-door end 520 and a second, e.g., catwalk/drawworks side, end 522 of the beam 200. The sheaves 511, 514 may be positioned proximate to the catwalk end 522. The lines 501, 502 may be received through the sheaves 507-514. In an embodiment, the line 501 may be received through the sheaves 507, 508, 509, 510, 511, and the line 502 may be received through the sheaves 512, 513, 509, 510, 514. The sheaves 509, 510 may thus receive both lines 501, 502 separately, and may thus be configured as a double-sheave, or may be two separate sheaves, such that the lines 504, 506 are free to move independently of on another.

The arrangement of the sheaves 507-514 may be configured to support movement of the trolley 500 (and thus the remainder of the gripping assembly 101) in the two axes x, y by rotational movement of the drives 104, 106. Each of the drives 104, 106 may have three modes of operation: clockwise rotation (first rotational direction), counter-clockwise rotation (second rotational direction), and locked/no-rotation. In the first two modes of operation, the drives 104, 106 are energized to rotate and apply a tension to the respective lines 501, 502, whereas in the locked/no-rotation mode, the drives 104, 106 are stationary and generally do not apply tension on the respective lines 501, 502.

When the drives 104, 106 are both operated in the first mode, as shown in FIG. 5, or both operated in the second mode (i.e., the drives 104, 106 both drive rotation in the same rotational direction), the result is movement of the trolley 500 in either direction along the y-axis, i.e., along the beam 200. For example, the drives 104, 106 may both drive rotation in a clockwise direction (first mode). The rotation of the drives 104, 106 in the clockwise direction applies tension to the lines 501, 502. The tension in both lines 501, 502 is transmitted to the trolley 500, on the same side thereof where the lines 501, 502 are connected thereto. Thus, the forces in the y-axis on the trolley 500 may work together to move the trolley 500 in the x-axis. In the x-axis, by rotating the drive 104, a force is initiated between the sheave 513 and the drive 104, but an opposing force draws the sheave 508 toward the sheave 509 by the rotation of the drive 106. Similar cancelling forces may be applied to the sheaves 514 and 512. Thus, the beam 200 may remain stationary in the x-axis.

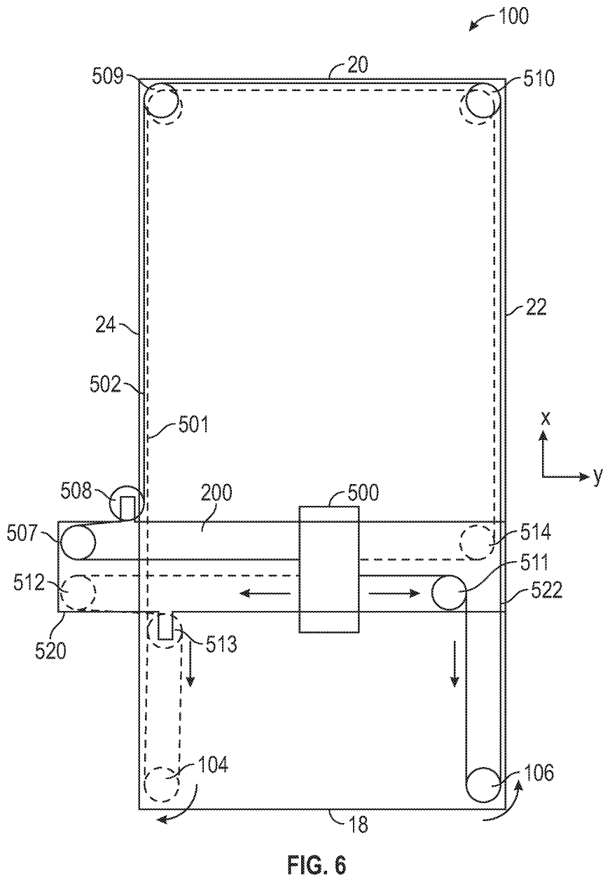

To move the beam 200 in the x-axis, the drives 104, 106 may rotate in opposite directions. Depending on the particular direction of rotation of the drives 104, 106, the beam 200 may move either opposite direction along the x-axis. For example, the drive 104 may operate in the first mode (clockwise), while the drive 106 may operate in the second mode (counter-clockwise), as shown in FIG. 6. In such case, the lines 501, 502 may pull the trolley 500 in opposite directions in the y-axis, resulting in the trolley 500 remaining stationary with respect to the beam 200. However, the forces on the sheaves 513, 511 may now be in the same direction, causing the beam 200 to move in the x-axis, toward the driller's side 18, in this case.

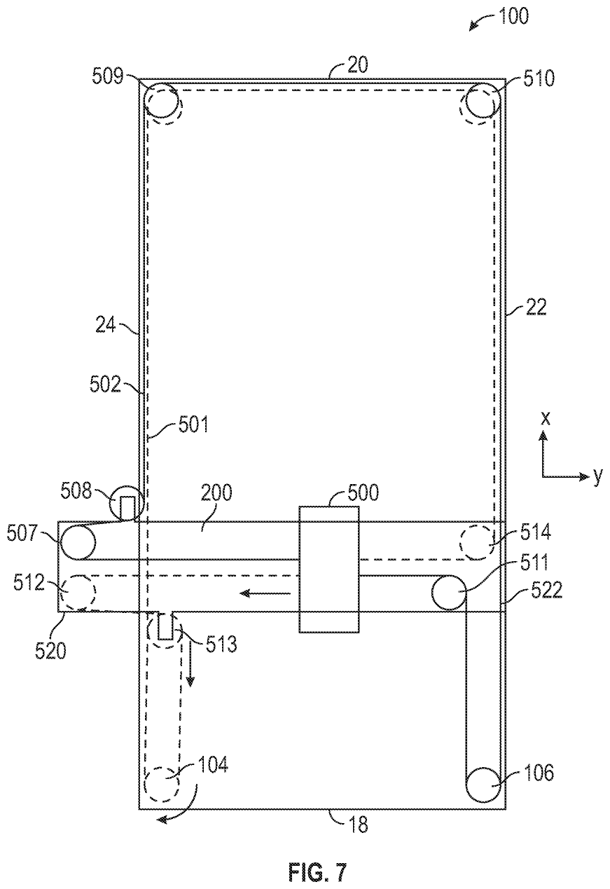

In addition, one of the drives 104, 106 may be operated in the third mode (no-rotation), while the other is operated in the first or second mode, which results in simultaneous movement of the beam 200 and the trolley 500 (i.e., movement along both axes). For example, as shown in FIG. 7, the drive 104 may operate in the first mode (clockwise rotation) while the drive 106 may operate in the third mode (no-rotation). The drive 104 may thus apply a downward (toward the driller's side 18) force in the x-direction, while pulling the trolley 500 toward the left, while the drive 106 applies less or no counteracting forces. The result is the aforementioned dual-axes movement, in this case, of the beam 200 toward the driller's side 18 and the trolley 500 toward the V-door side 24.

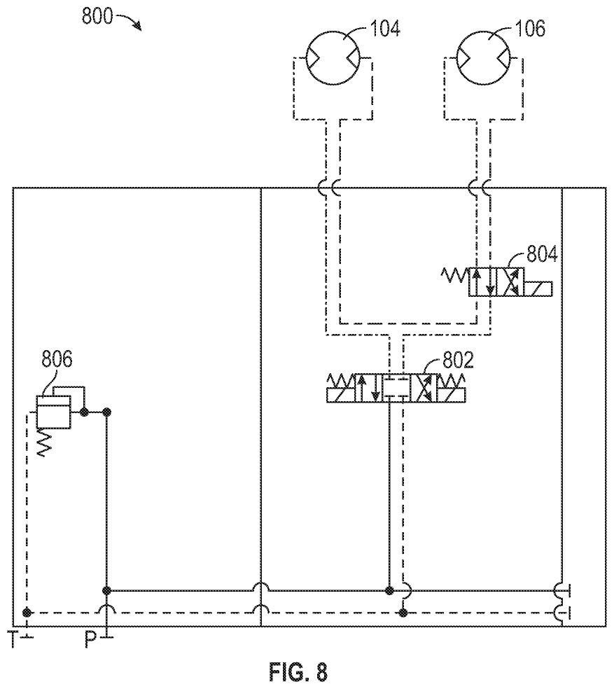

The drives 104, 106 may be hydraulically powered, e.g., using a hydraulic circuit. FIG. 8 illustrates a schematic of a hydraulic circuit 800, according to an embodiment. The hydraulic circuit 800 may provide for two modes of operation of the two drives 104, 106, but may not provide the third mode (no-rotation). The hydraulic circuit 800 may include a first directional valve 802 and a second directional valve 804. The valves 802, 804 may be solenoid valves. Further, the first valve 802 may be a proportional valve, e.g., to control the power sent to the drives 104, 106. The second valve 804 may not be proportional.

The first and second valves 802, 804 may each direct hydraulic fluid in two possible directions. Thus, the first and second valves 802, 804 may be referred to herein as having two positions, with it being appreciated that either may be proportional, as explained above. With each valve 802, 804 having two positions, four potential combinations for the hydraulic circuit 800 are provided. The four positions may correspond to the four potential drive direction combinations of the two drives 104, 106 (both clockwise, both counterclockwise, one clockwise and the other counterclockwise, one counterclockwise and the other clockwise). The first valve 802 may also have an off position, in which hydraulic power is blocked from reaching the drives 104, 106, allowing the system to be at rest.

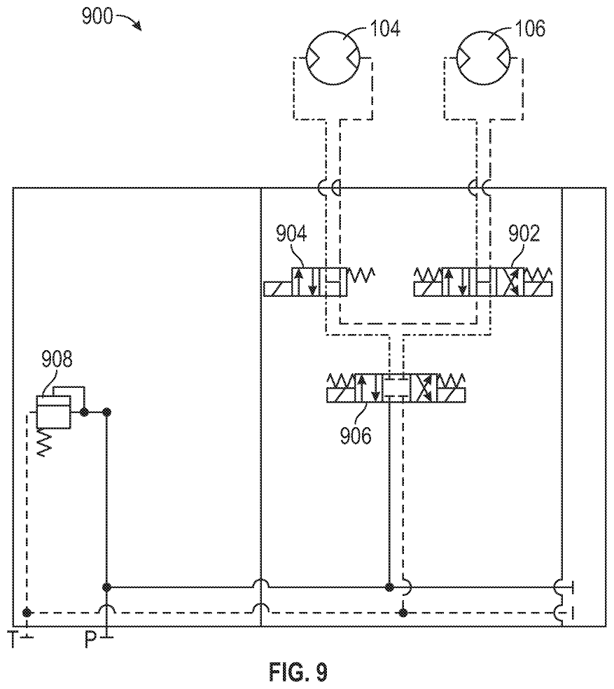

FIG. 9 illustrates a diagram of another hydraulic circuit 900, according to an embodiment. The circuit 900 may include a first valve 902, a second valve 904, a third valve 906, and a fourth valve 908. The fourth valve 908 may be a pressure-relief valve. The valves 902, 904, 906 may be solenoid valves, any one or more of which may be proportional. The valve 904 may have two positions, one that allows fluid flow and one that blocks it. When flow is blocked by the valve 904, the drive 104 may not rotate (third mode). Similarly, the first valve 902 may include an off position, but may also include a forward and reverse position. Finally, the third valve 906 may include forward, reverse, and off positions, as well. Thus, the third valve 906 in the off position may result in both drives 104, 106 being at rest (third mode). When the third valve 906 is not in the off position, there may be nine possible operating conditions, which may correspond to the three different modes allows for each of the drives 104, 106.

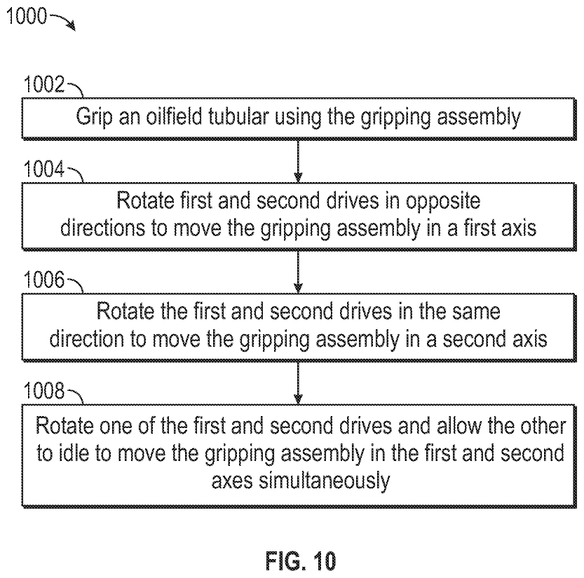

FIG. 10 illustrates a flowchart of a method 1000 for moving an oilfield tubular into/out of a racking board 14, according to an embodiment. The method 1000 may proceed by operation of one or more embodiments of the transfer bridge crane 100 discussed above, for example.

The method 1000 may include gripping an oilfield tubular using the engaging device 103 of the gripping assembly 101 of the transfer bridge crane 100, as at 1002. For example, the engaging device 103 may receive the oilfield tubular from a pipe handler, through the V-door side 24 of the support structure 16.

The method 1000 may also include moving the gripping assembly 101 while it is engaging the oilfield tubular. As explained above, the gripping assembly 101 may be moved in a first axis, a second axis, or simultaneously in the first and second axes depending on the operation of the drives 104, 106.

Accordingly, the method 1000 may include rotating the drives 104, 106 in opposite rotational directions to move the beam 200, and thus the gripping assembly 101 connected thereto, in the first axis, as at 1004. The direction of movement in the first axis may depend on which drive 104 is rotating in which direction, as explained above. It will be appreciated that in this context, “rotating the drive 104, 106” refers to applying rotational force thereto, e.g., via hydraulics, so as to apply tension to the lines 501, 502, in contrast to non-rotating.

The method 1000 may include rotating the drives 104, 106 in the same rotational direction to move the gripping assembly 101 in the second axis, along the beam 200, as at 1006. Again, the direction of movement in the second axis may depend on in which direction the drives 104, 106 are rotating.

The method 1000 may further include rotating the drive 104, while allowing the drive 106 to be non-rotating. This may result in movement of the gripping assembly 101 in both axes simultaneously.

The method 1000 may thus result in the movement of the oilfield tubular engaged by the gripping assembly 101. Depending on the type of operation being conducted, the transfer bridge crane 100 may thus be operable to receive the oilfield tubular from a pipe handler and place the oilfield tubular in the racking board 14, or may receive the oilfield tubular from the racking board 14 and provide it to another pipe handling device.

The method 1000 may also include tracking a position of the gripping assembly 101, as at 1010. The position may be tracked using encoders on the drives 104, 106, for example. In such an embodiment, the encoders may be programmed with a “home position”, which may serve as the datum from which the movement of the gripping assembly 101 may be determined. The home position may be selected arbitrarily as any position within the range of motion for the gripping assembly 101. The x and y coordinates may then be calculated as follows:

X=Average(CurrentA−HomeA, CurrentB−HomeB)

Y=(CurrentA−HomeA)−(CurrentB−HomeB)

where X and Y are the coordinates in the respective axes, currentA and currentB are the angular positions of the encoders for the drives 104, 106, respectively, and HomeA and HomeB are the encoder positions for the drives 104, 106, respectively, at the home position.

where A and B are the encoders, Home represents the encoder value at some trolley homing position, which could be known using a limit switch on each axis, Current represents the current encoder value, and X and Y are relative to the primary axes of the RMC and equal to 0 when the trolley and gantry are on their homes.

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial configuration. The terms “couple,” “coupled,” “connect,” “connection,” “connected,” “in connection with,” and “connecting” refer to “in direct connection with” or “in connection with via one or more intermediate elements or members.”

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for moving a bridge crane, comprising:
a first drive coupled to a support structure;
a second drive coupled to the support structure;
a first sheave coupled to the support structure;
a second sheave coupled to the support structure;
a plurality of third sheaves coupled to a beam of the bridge crane, wherein the beam is movable in a first axis;
a first line coupled to the first drive, the first sheave, the second sheave, and one or more of the third sheaves, wherein the first line is coupled to a gripping assembly that is coupled to the beam and movable in a second axis, along the beam; and
a second line coupled to the second drive, the first sheave, the second sheave, and one or more of the third sheaves, wherein the second line is coupled to the gripping assembly, and
wherein rotating the first and second drives causes the beam and the gripping assembly to move in the first axis, the gripping assembly to move in the second axis along the beam, or both.

2. The system of claim 1, wherein the first line is connected on one end to a first side of the gripping assembly, and wherein the first line is connected on an opposite end to a second side of the gripping assembly, the first side being opposite to the second side.

3. The system of claim 2, wherein the second line is connected on one end to the first side of the gripping assembly, and wherein the second line is connected on an opposite end to the second side of the gripping assembly.

4. The system of claim 1, wherein the first drive is configured to selectively move in a first rotational direction and a second rotational direction, and wherein the second drive is configured to selectively move in the first rotational direction and the second rotational direction.

5. The system of claim 4, wherein, when the first drive and the second drive both move in the first rotational direction, the gripping assembly is moved in a first direction in the second axis along the beam.

6. The system of claim 5, wherein, when the first drive and the second drive both move in the second rotational direction, the gripping assembly is moved in a second direction in the second axis along the beam, the second direction being opposite to the first direction.

7. The system of claim 6, wherein, when the first drive moves in the first rotational direction and the second drive moves in the second rotational direction, the beam is moved in a first direction along the first axis.

8. The system of claim 7, wherein, when the first drive moves in the second rotational direction and the second drive moves in the first rotational direction, the beam is moved in a second direction along the first axis, the second direction along the first axis being opposite to the first direction along the first axis.

9. The system of claim 8, wherein, when the first drive moves in the first rotational direction and the second drive is non-rotating, the beam moves in the first direction along the first axis and the gripping assembly moves in the first direction along the second axis simultaneously.

10. The system of claim 1, wherein the first and second drives each comprise one or more capstan drives.

11. A bridge crane for moving oilfield tubulars into a racking board, the bridge crane comprising:
a horizontal beam coupled to a support structure and configured to move in a first axis with respect to the support structure, the racking board being coupled to the support structure;
a gripping assembly coupled to the beam and configured to move in a second axis with respect thereto, wherein the gripping assembly comprises an engaging device configured to handle an oilfield tubular and move the oilfield tubular within the support structure; and
a system for moving the beam and the gripping assembly, comprising:
a first drive coupled to the support structure;
a second drive coupled to the support structure;
a first sheave coupled to the support structure;
a second sheave coupled to the support structure;
a plurality of third sheaves coupled to the beam;
a first line coupled to the first drive, the first sheave, the second sheave, and one or more of the third sheaves, wherein the first line is connected to the gripping assembly; and
a second line coupled to the second drive, the first sheave, the second sheave, and one or more of the third sheaves, wherein the second line is connected to the gripping assembly,
wherein actuation of the first and second drives causes the beam and the gripping assembly to move in the first axis, the gripping assembly to move in the second axis along the beam, or both.

12. The crane of claim 11, wherein the first and second axes are substantially perpendicular.

13. The crane of claim 11, wherein the first line is connected on one end to a first side of the gripping assembly, and wherein the first line is connected on an opposite end to a second side of the gripping assembly, the first side being opposite to the second side.

14. The crane of claim 13, wherein the second line is connected on one end to the first side of the gripping assembly, and wherein the second line is connected on an opposite end thereof to the second side of the gripping assembly.

15. The crane of claim 11, wherein the first drive is configured to selectively move in a first rotational direction and a second rotational direction, and wherein the second drive is configured to selectively move in the first rotational direction and the second rotational direction.

16. The crane of claim 15, wherein:
when the first drive and the second drive both move in the first rotational direction, the gripping assembly is moved in a first direction in the second axis along the beam, and
when the first drive and the second drive both move in the second rotational direction, the gripping assembly is moved in a second direction in the second axis along the beam, the second direction being opposite to the first direction.

17. The crane of claim 16, wherein:
when the first drive moves in the first rotational direction and the second drive moves in the second rotational direction, the beam is moved in a first direction along the first axis, and
when the first drive moves in the second rotational direction and the second drive moves in the first rotational direction, the beam is moved in a second direction along the first axis, the second direction along the first axis being opposite to the first direction along the first axis.

18. The crane of claim 17, wherein, when the first drive moves in the first rotational direction and the second drive is non-rotating, the beam moves in the first direction along the first axis and the gripping assembly moves in the first direction along the second axis simultaneously.

19. The crane of claim 11, wherein the gripping assembly comprises an arm extending downward from a connection between the gripping assembly and the beam, wherein the arm is coupled to the engaging device.

20. A method, comprising:
engaging an oilfield tubular using an engaging device of a gripping assembly of a bridge crane;
moving the gripping assembly in a first axis with respect to a support structure of the bridge crane, wherein moving the gripping assembly in the first axis comprises moving a horizontal beam coupled to the gripping assembly in the first axis by driving a first drive and a second drive in opposite rotational direction; and
moving the gripping assembly in a second axis with respect to the support structure, wherein moving the gripping assembly in the second axis comprises moving the gripping assembly in the second axis with respect to the horizontal beam by driving the first and second drives in the same rotational direction,
wherein driving the first drive to rotate applies a tension on a first line, wherein the first line is received through one or more first sheaves coupled to the beam and is connected to the gripping assembly, such that the first line transmits the force applied by the rotation of the first drive to both the beam and the gripping assembly, and
wherein driving the second drive to rotate applies a tension on a second line, wherein the second line is received through one or more second sheaves coupled to the beam and is connected to the gripping assembly, such that the second line transmits the force applied by the rotation of the second drive to both the beam and the gripping assembly.
